(19) United States
(12) Patent Application Publication
(10) Pub. No.: US 2012/0249718 A1
(43) Pub. Date: Oct. 4, 2012

(54) PHOTONIC CRYSTAL COLOR PRINTING PAPER AND METHODS OF PRINTING AND FABRICATING THE SAME

(75) Inventors: Jin-seung Sohn, Seoul (KR); Sang-hun Lee, Seoul (KR); In-kyeong Yoo, Gyeonggi-do (KR); Eun-hyoung Cho, Gyeonggi-do (KR)

(73) Assignee: SAMSUNG ELECTRONICS CO., LTD., Suwon-si (KR)

(21) Appl. No.: 13/439,147

(22) Filed: Apr. 4, 2012

(30) Foreign Application Priority Data
Apr. 4, 2011 (KR) 10-2011-0030782

(51) Int. Cl. B41J 2/435; B05D 5/06; G02B 1/10; G02B 5/09; G02B 27/14

(52) U.S. Cl. 347/262; 359/850; 359/865; 359/636; 359/584; 427/162

(57) ABSTRACT

A color printing paper includes a substrate having a printing region and a plurality of photonic crystal patterns formed on the printing region. The plurality of photonic crystal layer patterns have different respective optical reflection characteristics. The printing method includes selecting pixels including a plurality of photonic crystal layer patterns that express at least one of a red color, a green color, and a blue color, and changing optical reflection characteristics of at least a portion of the plurality of photonic crystal layer patterns of the selected pixels.

### CROSS-REFERENCE TO RELATED APPLICATIONS

This application claims the benefit of Korean Patent Application No. 10-2011-0030782, filed on Apr. 4, 2011, in the Korean Intellectual Property Office, the disclosure of which is incorporated herein in its entirety by reference.

### BACKGROUND

1. Field

Example embodiments relate to printing papers, methods of printing information on the printing papers, and/or methods of fabricating the printing papers, for example, photonic crystal color printing papers, methods of printing information on the photonic crystal color printing papers and/or methods of fabricating the photonic crystal color printing papers.

2. Description of the Related Art

Due to the development of printing technology, a printing medium may include information (letters, photographs, pictures, etc.) printed in mono-color or various colors, or may include information designed in various shapes. Materials of printing media are mostly papers, and different materials such as cellophane, poly ethylene, vinyl, woods, glasses, ceramics, and metals are used according to the purpose of use. Printing may be performed in various methods according to materials of the printing media. Except in the case of printing in an embossed method or an engraved method, most printings are performed by using an ink or a toner.

Except for the embossed or engraved printing, when information is printed using a printing material, for example, dye, ink, or toner, the information printed on a medium may be decolorized or discolored due to surroundings (illumination, atmosphere air, temperature, humidity, etc.) of the medium. Also, since the current printing media are readily copied or duplicated, information may be difficult to keep safely.

### SUMMARY

Some example embodiments provide color printing papers using a structural color of a photonic crystal to prevent or inhibit printed information decolorization or discoloration that may be caused when printings are performed using a dye. Some example embodiments provide methods of printing information on the color printing papers. Some example embodiments provide methods of fabricating the color printing papers.

Additional aspects will be set forth in part in the description which follows and, in part, will be apparent from the description, or may be learned by practice of example embodiments.

According to an example embodiment, a color printing paper includes a substrate including a printing region, and a plurality of photonic crystal layer patterns formed on the printing region. The plurality of photonic crystal layer patterns have different respective optical reflection characteristics.

The substrate may include one of a flexible material and a hard material. The photonic crystal color printing paper may further include a transparent layer between the substrate and the plurality of photonic crystal layer patterns. The plurality of photonic crystal layer patterns may include distributed Bragg reflector (DBR) layers.

The plurality of photonic crystal layer patterns may include a plurality of material layers that are sequentially stacked. The plurality of material layers may be first and second material layers, and the first and second material layers may have different respective reflection characteristics. The plurality of photonic crystal layer patterns may have a reflection characteristic that is greater than a reflection characteristic of the substrate.

The different respective optical reflection characteristics of the plurality of photonic crystal layer patterns may be at least partially defined by dimensions of the plurality of photonic crystal layer patterns. The different respective optical reflection characteristics of the plurality of photonic crystal layer patterns may be at least partially defined by a pitch between the plurality of photonic crystal layer patterns.

The color printing paper may further include an optical reflection inhibiting film covering at least a portion of the plurality of photonic crystal layer patterns. At least three sub-pixels may include the plurality of photonic crystal layer patterns, and the at least three sub-pixels may be included in each of a plurality of pixels formed on the printing region.

According to an example embodiment, a method of printing information on a photonic crystal color printing paper includes selecting pixels including a plurality of photonic crystal layer patterns that express at least one of a red color, a green color, and a blue color; and changing optical reflection characteristics of at least a portion of the plurality of photonic crystal layer patterns of the selected pixels.

The changing the optical reflection characteristics may include increasing an optical transmittance of at least a portion of the plurality of photonic crystal layer patterns.

The changing the optical reflection characteristics may include covering at least a portion of the plurality of photonic crystal layer patterns using an optical reflection inhibiting film. The changing the optical reflection characteristics may include removing at least a portion of the plurality of photonic crystal layer patterns.

The selecting the pixels including the plurality of photonic crystal layer patterns may include defining dimensions of the plurality of photonic crystal layer patterns, and defining a pitch between the plurality of photonic crystal layer patterns.

According to an example embodiment, a method of fabricating a color printing paper includes providing a substrate including a printing region, and forming a plurality of photonic crystal layer patterns on the printing region. The plurality of photonic crystal layer patterns have different respective optical reflection characteristics.

A transparent layer may be formed between the substrate and the plurality of photonic crystal layer patterns. An optical reflection inhibiting film may be formed to cover at least a portion of the plurality of photonic crystal layer patterns.

The forming the plurality of photonic crystal layer patterns on the printing region may include forming a plurality of pixels on the printing region. Each of the plurality of pixels may include at least three sub-pixels, and the at least three sub-pixels may include the plurality of photonic crystal layer patterns.

The photonic crystal color printing paper according to an example embodiment expresses printed information by including pixels that include a plurality of photonic crystal layer patterns in a printing region. The printed information is expressed by an inherent optical characteristic of the photonic crystal layer patterns, and a conventional material such as ink, dye, or toner for printing information is not used. Therefore, the printed information is not decolorized or discolored. Accordingly, the photonic crystal color printing paper may be effectively used for an outdoor advertisement.

Also, since the printed information is expressed by inherent optical characteristic of the photonic crystal layer patterns of the photonic crystal color printing paper, copy and duplication of information is difficult, thereby preventing or inhibiting counterfeit. The photonic crystal color printing paper may be used as a method to block particular light by setting up dimensions of photonic crystal layer patterns that constitute the pixels of the photonic crystal color printing paper to have a high reflection rate with respect to particular light (for example, ultraviolet rays or infrared rays). Also, the photonic crystal color printing paper may be used in print for a particular purpose by setting up the dimensions of the photonic crystal layer patterns to have a high reflection rate with respect to light outside the range of a visible light region.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view of a photonic crystal color printing paper for explaining a principle of realization of a structure color for expressing printed information, according to an example embodiment;

FIG. 2 is a cross-sectional view showing another configuration of a photonic crystal layer pattern of FIG. 1;

FIG. 3 is a plan view of a photonic crystal color printing paper according to an example embodiment;

FIG. 4 is a cross-sectional view taken along a line 4-4′ of FIG. 3;

FIG. 5 is a magnified plan view of a region (A1) on which pixels of FIG. 3 are arranged; and

FIGS. 6A through 6C are plan views for explaining a method of printing on a photonic crystal color printing paper according to an example embodiment.

### DETAILED DESCRIPTION

Example embodiments will now be described more fully with reference to the accompanying drawings in which example embodiments are shown. In the drawings, the thicknesses of layers and regions are exaggerated for clarity. Example embodiments may, however, be embodied in many different forms and should not be construed as limited to the example embodiments set forth herein. Rather, these example embodiments are provided so that this disclosure will be thorough and complete, and will fully convey the scope of the present inventive concept to those skilled in the art.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. A photonic crystal color printing paper according to an example embodiment will now be described.

FIG. 1 is a perspective view of a photonic crystal color printing paper for explaining a principle of realization of a structure color for expressing printed information according to an example embodiment.

Referring to FIG. 1, a plurality of photonic crystal layer patterns 32 are arranged on a substrate 30. The substrate 30 may be formed of a material transparent to incident light or may be an optical wave guide. The substrate 30 may be, for example, a glass substrate, a polymer substrate, a metal substrate, or a silicon wafer. The substrate 30 may be flexible. The photonic crystal layer patterns 32 may be a grating layer, and may have a reflection characteristic greater than that of the substrate 30.

The photonic crystal layer patterns 32 may be formed of silicon. Light L3 that transmits through the photonic crystal layer patterns 32 and the substrate 30 and light L2 that is reflected above the substrate 30 by the photonic crystal layer patterns 32 are determined from light L1 that enters the substrate 30 according to the dimension of each of the photonic crystal layer patterns 32 and a pitch (nm) P1 between the photonic crystal layer patterns 32.

The dimension may include height H1 (nm), width d1 (nm), and length d2 (nm) of each of the photonic crystal layer patterns 32. The width d1 and the length d2 of each of the photonic crystal layer patterns 32 may be different. Under a condition (hereinafter a first condition) in which the dimensions H1, d1, and d2 of the photonic crystal layer patterns 32 and the pitch P1 of the photonic crystal layer patterns 32 reflect red light and do not reflect other light, only red light components in the light L1 that are incident to the substrate 30 are reflected, and the rest of the components of light, for example, green light or blue light, may transmit through the photonic crystal layer patterns 32 and the substrate 30.

Also, under a condition (hereinafter a second condition) in which the dimensions H1, d1, and d2 of the photonic crystal layer patterns 32 and the pitch P1 of the photonic crystal layer patterns 32 reflect green light and do not reflect other light, only green light components in the light L1 that are incident to the substrate 30 are reflected, and the rest of the components of light, for example, red light or blue light, may transmit through the photonic crystal layer patterns 32 and the substrate 30.

Also, under a condition (hereinafter a third condition) in which the dimensions H1, d1, and d2 of the photonic crystal layer patterns 32 and the pitch P1 of the photonic crystal layer patterns 32 reflect blue light and do not reflect other light, only the blue light components in the light L1 that are incident to the substrate 30 are reflected, and the rest of the components of light, for example, green light or red light, may transmit through the photonic crystal layer patterns 32 and the substrate 30.

As an example of the first condition, the height H1, the width d1, and the length d2 of a photonic crystal layer pattern 32 respectively may be about 130 nm, about 160 nm, and about 160 nm, and the pitch P1 thereof may be about 390 nm.

As an example of the second condition, the height H1, the width d1, and the length d2 of the photonic crystal layer pattern 32 respectively may be about 130 nm, about 115 nm, and about 115 nm, and the pitch P1 thereof may be about 240 nm. As an example of the third condition, the height H1, the width d1, and the length d2 of the photonic crystal layer pattern 32 respectively may be about 130 nm, about 90 nm, and about 90 nm, and the pitch P1 thereof may be about 200 nm. The first through third conditions are not limited to the above examples.

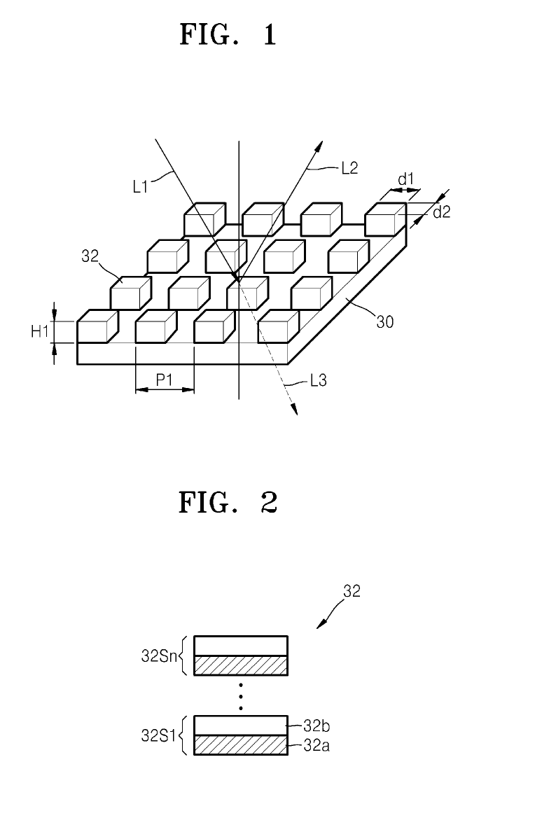

FIG. 2 is a cross-sectional view showing another configuration of the photonic crystal layer pattern 32 of FIG. 1. Referring to FIG. 2, the photonic crystal layer pattern 32 may be a DBR layer. The photonic crystal layer pattern 32 includes, sequentially stacked, a plurality of material layers 32S1 through 32Sn. Each of the material layers 32S1 through 32Sn includes sequentially stacked a first material layer 32a and a second material layer 32b. The first and second material layers 32a and 32b are optically transparent and may have reflection characteristics different from each other. When the photonic crystal layer pattern 32 is a DBR layer, the optical reflection characteristics of the photonic crystal layer pattern 32 may further be improved.

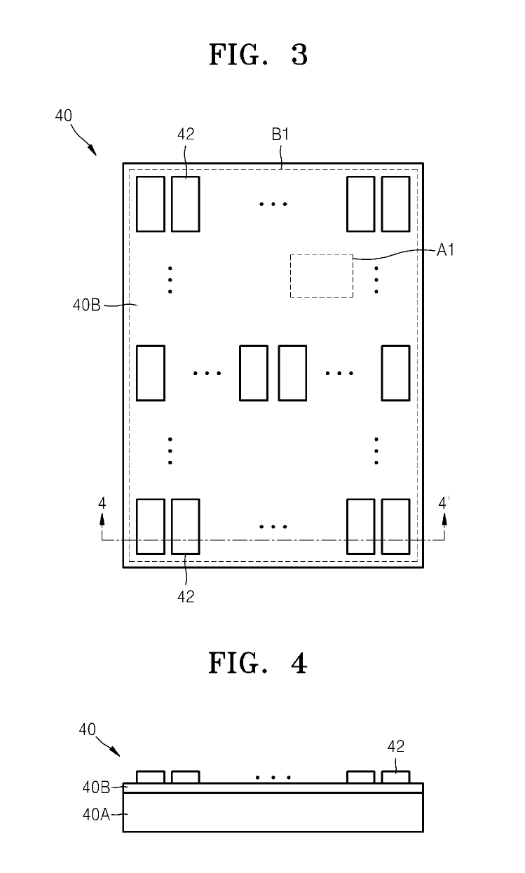

FIG. 3 is a plan view of a photonic crystal color printing paper 40 according to an example embodiment, and FIG. 4 is a cross-sectional view taken along a line 4-4′ of FIG. 3. Referring to FIGS. 3 and 4, the photonic crystal color printing paper 40 includes a substrate 40A and a transparent layer 40B formed on a substrate 40A, and a plurality of pixels 42 on a printing region B1 of the transparent layer 40B. The substrate 40A and the transparent layer 40B together may be referred to as a substrate. Although the substrate 40A and the transparent layer 40B are separately depicted in FIG. 4, a single layer substrate may be utilized instead of the substrate 40A and the transparent layer 40B.

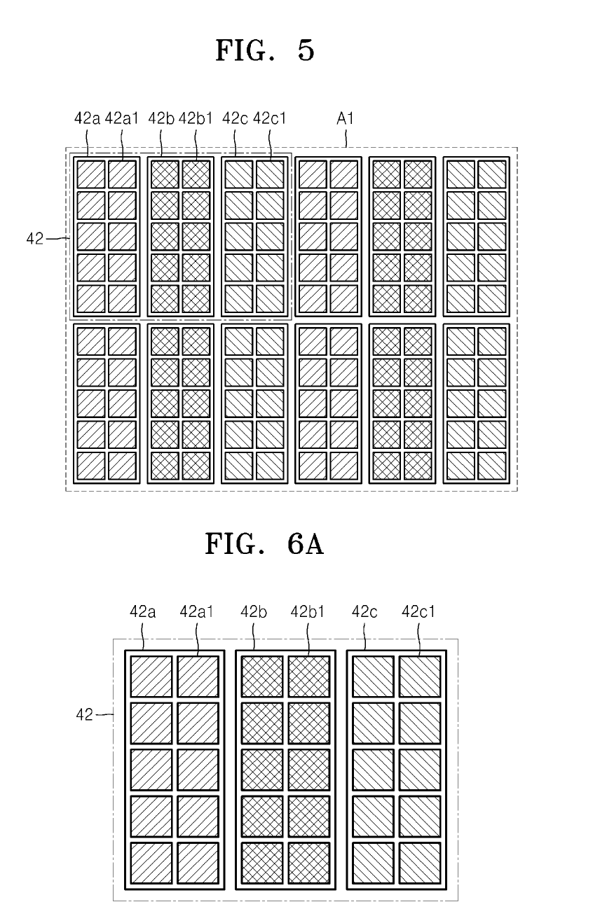

The substrate 40A may not be transparent, and the transparent layer 40B may be the substrate 30 described with reference to FIG. 1. The substrate 30 and the transparent layer 40B may be flexible or may not be flexible, and this applies to the case when the substrate is a single layer. The pixels 42 are regularly arranged in a matrix. Each of the pixels 42 includes the photonic crystal layer patterns 32 as described with reference to FIG. 1, and FIG. 5 shows an example of a pixel 42 including the photonic crystal layer patterns 32. FIG. 5 is a magnified plan view of a region (A1) on which the pixels 42 of FIG. 3 are arranged.

Referring to FIG. 5, each of the pixels 42 includes first through third sub-pixels 42a, 42b, and 42c. The first through third sub-pixels 42a, 42b, and 42c respectively express red, green, and blue colors. The first through third sub-pixels 42a, 42b, and 42c include a plurality of photonic crystal layer patterns 42a1, 42b1, and 42c1, respectively. The photonic crystal layer patterns 42a1, 42b1, and 42c1 respectively included in the first through third sub-pixels 42a, 42b, and 42c have dimensions designed so that the first through third sub-pixels 42a, 42b, and 42c may respectively reflect desired (or, alternatively predetermined) light.

Accordingly, the dimensions of the photonic crystal layer patterns 42a1, 42b1, and 42c1 respectively included in the first through third sub-pixels 42a, 42b, and 42c may be different in each of the first through third sub-pixels 42a, 42b, and 42c. However, in FIG. 5, for convenience of drawing, the dimensions of the first through third sub-pixels 42a, 42b, and 42c are depicted to be the same. The configuration and optical reflection characteristics of the photonic crystal layer patterns 42a1, 42b1, and 42c1 of the first through third sub-pixels 42a, 42b, and 42c may be the same as those of the photonic crystal layer patterns 32 described with reference to FIG. 1.

Accordingly, a first sub-pixel 42a reflects only red light of light incident to the pixel 42, and the second and third sub-pixels 42b and 42c respectively reflect only green light and blue light of the incident light. The pixels 42 may express various colors by controlling optical reflection regions of the first through third sub-pixels 42a, 42b, and 42c.

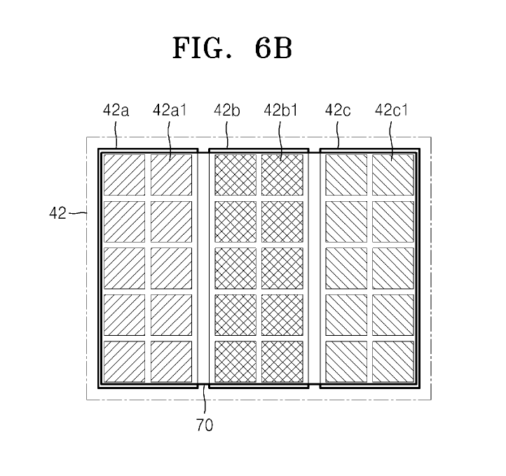

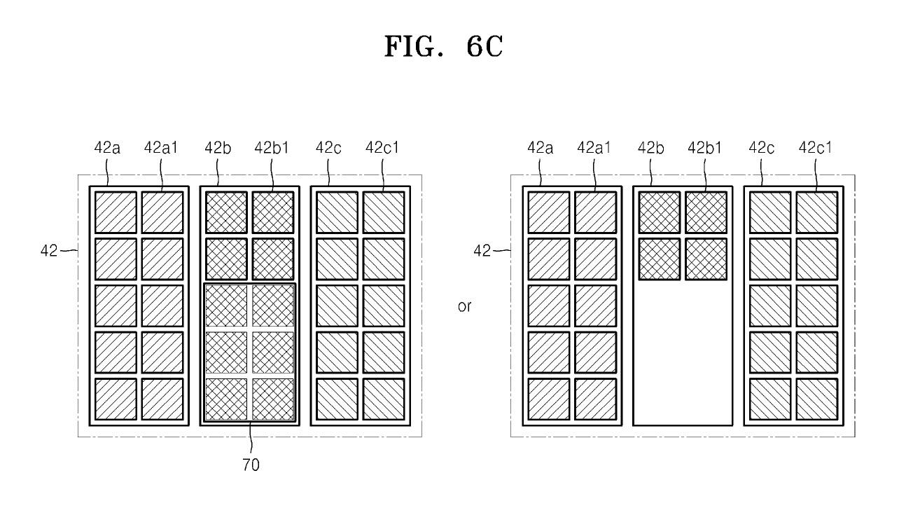

A method of printing (hereinafter, a printing method) onto the photonic crystal color printing paper 40 according to an example embodiment will now be described with reference to FIGS. 6A through 6C. The printing method, as an example, will be described with reference to the pixels 42 of FIG. 5.

All or at least a portion of the photonic crystal layer patterns 42a1, 42b1, and 42c1 of the first through third sub-pixels 42a, 42b, and 42c included in each of the pixels 42 are untreated or treated not to reflect light according to color information of contents (for example, letters, photographs, pictures, etc.) to be printed.

For example, as depicted in FIG. 6A, when the photonic crystal layer patterns 42a1, 42b1, and 42c1 of the first through third sub-pixels 42a, 42b, and 42c are untreated, the first through third sub-pixels 42a, 42b, and 42c respectively express red color R, green color G, and blue color B. Thus, the pixels 42 express white color.

Also, as depicted in FIG. 6B, when the photonic crystal layer patterns 42a1, 42b1, and 42c1 are treated so that all of the first through third sub-pixels 42a, 42b, and 42c may allow an incident light to be transmitted through, the pixels 42 do not reflect light. Thus, black color is expressed. Also, in the case of FIG. 6B, the treatment means covering the photonic crystal layer patterns 42a1, 42b1, and 42c1 of the first through third sub-pixels 42a, 42b, and 42c with a film 70. The film 70 may be a film that includes an optical reflection inhibiting film, an optical absorption film or an optical transparent film.

Also, as depicted in FIG. 6C, one or two of the sub-pixels selected from the first through third sub-pixels 42a, 42b, and 42c may be treated so that incident light may transmit therethrough. At this point, a region or regions of the one or two sub-pixels treated so that the incident light is transmitted therethrough may be the entire region or portions of the selected sub-pixels.

The case of FIG. 6C may be a case of covering a portion of the first through third sub-pixels 42a, 42b, and 42c using the film 70 (left drawing) or may be a case of removing the photonic crystal layer pattern included in the treatment region (right drawing). In the latter case, the removal of the photonic crystal layer pattern denotes a treatment of the corresponding photonic crystal layer pattern so as not to have a reflection characteristic, but to have optical transparency, for example, fusion of the photonic crystal layer pattern using a laser. In FIG. 6C, an area of the region treated according to color information of contents to be printed may vary.

Also, a portion of each of the first through third sub-pixels 42a, 42b, and 42c may be treated so that incident light may transmit through. In this case, regions of the first through third sub-pixels 42a, 42b, and 42c treated to transmit incident light therethrough may be different. In summary, the pixels 42 may express various colors, including a black color and a white color, by treating at least a portion of at least one sub-pixel of the first through third sub-pixels 42a, 42b, and 42c to transmit incident light therethrough or by not treating the at least a portion of at least one sub-pixel. The printing method with respect to the pixels 42 may be applied to other pixels 42 included in the photonic crystal color printing paper 40, and thus, desired information may be printed on the photonic crystal color printing paper 40.

A color that is expressed by the pixels 42 comes from inherent optical reflection and transmittance characteristics of each of the photonic crystal layer patterns 42a1, 42b1, and 42c1. Accordingly, a color, that is, printed information expressed by the pixels 42, may not be decolorized or discolored according to surroundings of the photonic crystal color printing paper 40. Also, the information printed on the photonic crystal color printing paper 40 may not be copied or duplicated without identical printed information, an identical photonic crystal color printing paper, and an identical printing device. Thus, the printed matter on the photonic crystal color printing paper 40 is secure.

In addition, the dimensions of the photonic crystal layer patterns 42a1, 42b1, and 42c1 may be set in order to reflect light outside the range of a visible light region, for example, ultraviolet rays or infrared rays. In this case, the photonic crystal color printing paper 40 may be used as a medium that blocks the ultraviolet rays or infrared rays. Also, the photonic crystal color printing paper 40 may be used as a printing paper for a particular purpose so that the printed information may be read under ultraviolet rays or infrared rays.

It should be understood that example embodiments described therein should be considered in a descriptive sense only and not for purposes of limitation. Descriptions of features or aspects within each example embodiment should typically be considered as available for other similar features or aspects in other example embodiments.

What is claimed is:

1. A color printing paper comprising:
a substrate including a printing region; and
a plurality of photonic crystal layer patterns formed on the printing region, the plurality of photonic crystal layer patterns having different respective optical reflection characteristics.

2. The color printing paper of claim 1, wherein the substrate comprises one of a flexible material and a hard material.

3. The color printing paper of claim 1, further comprising:
a transparent layer between the substrate and the plurality of photonic crystal layer patterns.

4. The color printing paper of claim 1, wherein the plurality of photonic crystal layer patterns comprise distributed Bragg reflector (DBR) layers.

5. The color printing paper of claim 4, wherein the plurality of photonic crystal layer patterns include first and second material layers, and the first and second material layers have different respective reflection characteristics.

6. The color printing paper of claim 1, wherein the plurality of photonic crystal layer patterns have a reflection characteristic that is greater than a reflection characteristic of the substrate.

7. The color printing paper of claim 1, wherein the different respective optical reflection characteristics of the plurality of photonic crystal layer patterns are at least partially defined by dimensions of the plurality of photonic crystal layer patterns.

8. The color printing paper of claim 7, wherein the different respective optical reflection characteristics of the plurality of photonic crystal layer patterns are at least partially defined by a pitch between the plurality of photonic crystal layer patterns.

9. The color printing paper of claim 1, further comprising:
an optical reflection inhibiting film covering at least a portion of the plurality of photonic crystal layer patterns.

10. The color printing paper of claim 1, wherein
at least three sub-pixels include the plurality of photonic crystal layer patterns; and
the at least three sub-pixels are included in each of a plurality of pixels formed on the printing region.

11. A method of printing information on a color printing paper, the method comprising:
selecting pixels including a plurality of photonic crystal layer patterns that express at least one of a red color, a green color, and a blue color; and
changing optical reflection characteristics of at least a portion of the plurality of photonic crystal layer patterns of the selected pixels.

12. The method of claim 11, wherein the changing the optical reflection characteristics comprises increasing an optical transmittance of at least a portion of the plurality of photonic crystal layer patterns.

13. The method of claim 11, wherein the changing the optical reflection characteristics comprises covering at least a portion of the plurality of photonic crystal layer patterns using an optical reflection inhibiting film.

14. The method of claim 11, wherein the changing the optical reflection characteristics comprises removing at least a portion of the plurality of photonic crystal layer patterns.

15. The method of claim 11, wherein the selecting the pixels including the plurality of photonic crystal layer patterns further comprises:
defining dimensions of the plurality of photonic crystal layer patterns; and
defining a pitch between the plurality of photonic crystal layer patterns.

16. The method of claim 11, wherein the plurality of photonic crystal layer patterns are distributed Bragg reflector (DBR) layers.

17. A method of fabricating a color printing paper comprising:
providing a substrate including a printing region; and
forming a plurality of photonic crystal layer patterns on the printing region, the plurality of photonic crystal layer patterns having different respective optical reflection characteristics.

18. The method of claim 17, further comprising:
forming a transparent layer between the substrate and the plurality of photonic crystal layer patterns.

19. The method of claim 18, further comprising:
forming an optical reflection inhibiting film covering at least a portion of the plurality of photonic crystal layer patterns.

20. The method of claim 17, wherein the forming the plurality of photonic crystal layer patterns on the printing region comprises:
forming a plurality of pixels on the printing region, each of the plurality of pixels including at least three sub-pixels, and the at least three sub-pixels including the plurality of photonic crystal layer patterns.
